(19) United States
(12) Patent Application Publication
(10) Pub. No.: US 2014/0282187 A1
(43) Pub. Date: Sep. 18, 2014

(54) Dynamic Partition and Visualization of a Dataset

(71) Applicants: Jock Douglas Mackinlay, Bellevue, WA (US); Christopher Stolte, Seattle, WA (US); Jun Kim, Sammamish, WA (US)

(72) Inventors: Jock Douglas Mackinlay, Bellevue, WA (US); Christopher Stolte, Seattle, WA (US); Jun Kim, Sammamish, WA (US)

(21) Appl. No.: 13/841,701

(22) Filed: Mar. 15, 2013

(51) Int. Cl. G06F 3/0484

(52) U.S. Cl. CPC G06F 3/0484
USPC 715/771

(57) ABSTRACT

A computer-implemented method of visualizing a dataset is implemented on a computer having memory, one or more processors, and a display. The method includes: rendering a plurality of marks on the display, each mark corresponding to a respective data sample in the dataset; in response to detecting a first user instruction, visually highlighting a subset of the plurality of marks in accordance with the first user instruction and generating a first data structure including the data samples associated with the highlighted marks; and in response to detecting a second user instruction, replacing the plurality of marks with two marks on the display, wherein a first mark corresponds to an aggregation result of the data samples associated with the highlighted marks and a second mark corresponds to an aggregation result of data samples associated with the non-highlighted marks.

### TECHNICAL FIELD

The disclosed implementations relate generally to data mining, and in particular, to systems and methods for dynamically partitioning a dataset into multiple groups and visualizing the groups on a display.

### BACKGROUND

Data visualization is an important aspect of data mining. Over the years, people have developed many software tools for generating different views of a dataset so that a data analyst can gain more insight into the dataset. But many of these views are visualization of a particular aspect (e.g., a subset) of the dataset and it is can be difficult for the data analyst to partition the subset into multiple groups and correlate the data samples from different groups on an individual or aggregated basis.

### SUMMARY

In accordance with some implementations described below, a computer-implemented method of visualizing a dataset is implemented on a computer having memory, one or more processors, and a display. The method includes: rendering a plurality of marks on the display, each mark corresponding to a respective data sample in the dataset; in response to detecting a first user instruction, visually highlighting a subset of the plurality of marks in accordance with the first user instruction and generating a first data structure including the data samples associated with the highlighted marks; and in response to detecting a second user instruction, replacing the plurality of marks with two marks on the display, wherein a first mark corresponds to an aggregation result of the data samples associated with the highlighted marks and a second mark corresponds to an aggregation result of data samples associated with the non-highlighted marks. Note that each data sample may include multiple data values, each data value corresponding to a respective field of the dataset, a single data value corresponding to a field of the dataset.

In response to detecting a third user instruction, the computer replaces the first mark with a group of marks on the display, wherein each mark in the group corresponds to a respective data sample in the first data structure.

The aggregation operation applied to the data samples is one selected from the group consisting of sum, average, median, count, standard deviation, variance, maximum, and minimum.

In response to detecting the first user instruction, the computer displays a table of entries in a pop-up window, each table entry corresponding to a respective data sample associated with one of the highlighted marks.

In response to detecting a fourth user instruction, the computer removes a table entry from the pop-up window and a data sample corresponding to the removed table entry from the first data structure and de-highlights a mark associated with the data sample.

In response to detecting a fifth user instruction, the computer visually highlights a second subset of the plurality of marks in accordance with the fifth user instruction and generates a second data structure including the data samples associated with the second subset of highlighted marks.

In response to detecting a sixth user instruction, the computer generates a third data structure by applying a predefined operation to the first data structure and the second data structure and a data view for visualizing the third data structure. For example, the predefined operation is one selected from the group consisting of union, intersection, complement, and Cartesian product.

In accordance with some implementations described below, a computer system for visualizing a dataset includes one or more processors; a display; and memory storing one or more programs. The one or more programs are configured to, when executed by the one or more processors, cause the one or more processors to: render a plurality of marks on the display, each mark corresponding to a respective data sample in the dataset; in response to detecting a first user instruction, visually highlight a subset of the plurality of marks in accordance with the first user instruction and generate a first data structure including the data samples associated with the highlighted marks; and in response to detecting a second user instruction, replace the plurality of marks with two marks on the display, wherein a first mark corresponds to an aggregation result of the data samples associated with the highlighted marks and a second mark corresponds to an aggregation result of data samples associated with the non-highlighted marks.

In accordance with some implementations described below, a non-transitory computer readable storage medium stores one or more programs configured for execution by a computer system that includes one or more processors, a display, and memory storing one or more programs. The one or more programs include instructions for: rendering a plurality of marks on the display, each mark corresponding to a respective data sample in the dataset; in response to detecting a first user instruction, visually highlighting a subset of the plurality of marks in accordance with the first user instruction and generating a first data structure including the data samples associated with the highlighted marks; and in response to detecting a second user instruction, replacing the plurality of marks with two marks on the display, wherein a first mark corresponds to an aggregation result of the data samples associated with the highlighted marks and a second mark corresponds to an aggregation result of data samples associated with the non-highlighted marks.

### BRIEF DESCRIPTION OF DRAWINGS

The aforementioned implementation of the invention as well as additional implementations will be more clearly understood as a result of the following detailed description of the various aspects of the invention when taken in conjunction with the drawings. Like reference numerals refer to corresponding parts throughout the several views of the drawings.

FIG. 1 is a block diagram illustrating the components of a computer, which is configured to visualize a dataset according to some implementations of the present application.

FIG. 2 is a flow chart illustrating a process of partitioning a dataset into two subsets and visually comparing the two subsets through user interactions with a graphical user interface according to some implementations of the present application.

FIGS. 3A to 3C are flow charts illustrating sub-processes of updating at least one of the two subsets and visualizing the updated subset through user interactions with a graphical user interface according to some implementations of the present application.

FIGS. 4A to 4Q are exemplary screenshots of visualizing a dataset according to some implementations of the present application.

### DETAILED DESCRIPTION

The present invention provides methods, computer program products, and computer systems for visualizing a dataset or a subset thereof. In a typical implementation, the present invention builds and displays a view of the dataset based on a user specification of the view. A more detailed description of the data visualization process can be found in U.S. Pat. No. 7,089,266, which is incorporated by reference in its entirety. As one skilled in the art will realize, the dataset can be a relational database, a multi-dimensional database, a semantic abstraction of a relational database, or an aggregated or unaggregated subset of a relational database, multi-dimensional database, or semantic abstraction. Fields are categorizations of data in a dataset. A tuple (also known as a data sample) is an entry of data (such as a record) in the dataset, specified by properties from fields in the dataset. A search query across the dataset returns one or more tuples.

A view is a visual representation of a dataset or a transformation of that dataset. Text tables, bar charts, line graphs, map views, and scatter plots are all examples of types of views. Views contain marks that represent one or more tuples of a dataset. In other words, marks are visual representations of tuples in a view. A mark is typically associated with a type of graphical display. Some examples of views and their associated marks are as follows:

| View Type | Associated Mark |
|---|---|
| Table | Text |
| Scatter Plot | Shape |
| Bar Chart | Bar |
| Gantt Plot | Bar |
| Line Graph | Line Segment |
| Circle Graph | Circle |

FIG. 1 is a block diagram illustrating the components of a computer system that is configured to visualize a dataset according to some implementations of the present application. The computer system 100 includes one or more processing units (CPUs) 180 for executing modules, programs, and/or instructions stored in memory 102 and thereby performing various data-processing operations; memory 102; user interface 184; storage unit 194; disk controller 192; and one or more communication buses 182 for interconnecting these components. In some implementations, the user interface 184 comprises a display device 186 and one or more input devices (e.g., keyboard 190 or mouse 188). The computer system 100 may also have a network interface card (NIC) 196 to enable data communication with other systems on a different network (e.g., the Internet).

In some implementations, the memory 102 includes high-speed random access memory, such as DRAM, SRAM, DDR RAM, or other random access solid state memory devices. In some implementations, the memory 102 includes non-volatile memory, such as one or more magnetic disk storage devices, optical disk storage devices, flash memory devices, or other non-volatile solid state storage devices. In some implementations, the memory 102 includes one or more storage devices remotely located from the computer system 100. Memory 102, or alternately the non-volatile memory device(s) within the memory 102, comprises a non-transitory computer readable storage medium. In some implementations, memory 102 or the computer readable storage medium of memory 102 stores the following elements, or a subset of these elements, and may also include additional elements:
an operating system 104 that includes procedures for handling various basic system services and for performing hardware dependent tasks;
a network communications module 106 that is used for connecting the computer system 100 to other devices via the NIC 196 and one or more communication networks (wired or wireless), such as the Internet, other wide area networks, local area networks, metropolitan area networks, and so on;
a database interface module 108 that is used for interacting with a local or remote database 150 through the NIC 196;
a data visualization engine 110 that is used for visualizing a dataset or a subset thereof stored in the database 150, the data visualization engine 110 further comprising: a data view processing module 112 for generating and/or updating a view of the dataset or a subset thereof, a set processing module 114 for generating and/or updating a set from a view of the dataset, and a set in/out comparison module 116 for visualizing a comparison of aggregation results between data samples in a set and data samples not in the set; and
a plurality of set records 120, each set (122-1, . . . , 122-M) including a set type 124 (e.g., static or dynamic), one or more fields 126 associated with the set, and one or more data samples 128 associated with the set.

FIG. 2 is a flow chart illustrating a process of partitioning a dataset into two subsets and visually comparing the two subsets through user interactions with a graphical user interface according to some implementations of the present application. Initially, the computer renders (201) a plurality of marks on its display, each mark corresponding to a respective data sample in the dataset. In order to generate an aggregated view of the dataset, a first user instruction is provided to the computer. In response to detecting (203) the first user instruction, the computer visually highlights (205) a subset of the plurality of marks in accordance with the first user instruction and generates a first data structure including the data samples associated with the highlighted marks. As a result, the data samples associated with the plurality of marks are partitioned into two sets, one set being associated with the highlighted marks on the display and the other set being associated with the non-highlighted marks on the display. In some implementations, the first data structure is in the form of a written expression characterizing the relationship between the corresponding data samples and one or more predefined conditions.

After partitioning the data samples into two sets, a data analyst may issue a second user instruction to the computer for visualizing the aggregation results associated with the two sets. In response to detecting (207) the second user instruction, the computer replaces the plurality of marks with two marks on the display such that a first mark corresponds to an aggregation result of the data samples associated with the highlighted marks and a second mark corresponds to an aggregation result of data samples associated with the non-highlighted marks. Note that there may or may not be a data structure for the data samples associated with the non-highlighted marks because, given that there is a data structure or an expression for the data samples associated with the plurality of marks on the display, a virtual data structure or expression is sufficient for defining the data samples associated with the marks not highlighted on the display.

FIG. 4A is an exemplary screenshot of a view of a dataset concerning the 2012 US presidential election, which is downloaded from the Federal Election Commission's website at http://www.fec.gov/pindex.shtml. In this example, the plurality of marks are organized as a bar chart, each mark depicting the difference in the total amount of contributions that the two candidates received from a particular state. In other words, the bars on the left side of the vertical axis represent states, e.g., Florida, Texas, and Utah, which made more campaign contributions to Mitt Romney than to Barack Obama. The bars on the right side of the vertical axis correspond to states such as California, Illinois, and New York, from which Barack Obama received more campaign donations than Mitt Romney. FIG. 4B is an exemplary screenshot of the same view of the dataset after the states are sorted by their respective campaign contributions, with Texas at the top and Illinois at the bottom of the bar chart. Although the two bar charts shown in FIGS. 4A and 4B provide some useful information about individual states, they offer limited information regarding the aggregated amount of campaign contributions received by the two camps. For example, it is difficult for a data analyst to tell the difference in the total amount of contributions to the two candidates from all the 50 states.

As shown in FIG. 4C, a user issues a first user instruction of selecting the states that donated more to Romney by dragging the mouse on the data view to define a box 401 that includes the bars on the left side of the vertical axis. FIG. 4D depicts the updated data view after the user release of the mouse button. In response to the first user instruction, the bars 403 in the box 401 are highlighted and the bars 405 outside the box 401 are not highlighted or grayed. A first pop-up window 407 appears near the highlighted bars 403, including options such as “Keep Only,” “Exclude,” “Set,” “View Data,” etc. In response to a user click on the “Set” option, a drop-down menu 409 appears on the display, listing set-related operations such as “Create Set.” In response to the user selection of the “Create Set” option, the computer generates a first data structure or an equivalent expression for the data samples associated with the highlighted bars 403.

FIG. 3A is a flow chart illustrating how to update data samples within a user-created set and visualize the updated set through user interactions with a graphical user interface. In response to detecting the first user instruction such as the user selection of the “Create Set” option, the computer displays (301) a table of entries in a pop-up window, each table entry corresponding to a respective data sample associated with one of the highlighted marks. FIG. 4E depicts a pop-up window 411 associated with the first data structure. The pop-up window 411 includes a table field 413 listing the data samples associated with the highlighted bars 403 and a set name field 415 through which the user can assign a name to the set. In this example, each entry in the table field 413 has a single data value, which is the name of a state that contributed more to the Romney campaign. In some other implementations, an entry in the table field 413 may include multiple data values corresponding to different fields of the dataset. In response to the user click on the “OK” button 417, the computer generates a new set named “More $ to Romney” and stores the new set in its own memory and/or in the database where the campaign contribution dataset is located.

In some implementations, the user can remove an entry from the table field 413 by issuing a fourth user instruction to the computer. In response to detecting (303) the fourth instruction, the computer removes (305) a table entry from the pop-up window as well as a data sample corresponding to the removed table entry from the first data structure. Sometimes, the computer also updates the data view by de-highlighting a mark associated with the removed data sample. As shown in FIG. 4E, a table entry has a “Delete” icon 412, which is highlighted when a user moves the mouse cursor onto the entry. In response to a user click of the “Delete” icon 412, the computer removes the entry from the table field 413. At the same time or subsequently, the bar corresponding to the deleted table entry is also de-highlighted in the data view shown in FIG. 4D such that the first data structure is consistent with the data view.

In some implementations, the data view shown in FIG. 4A includes a “Set” region 404 containing the set names (including “More $ to Romney”) created by the user. On the one hand, a set listed in the “Set” region 404 behaves like a field in the “Dimensions” region 400 or the “Measures” region 402. For example, the user can drag and drop a set from the “Set” region 404 into the column shelf 406 or the row shelf 408 to render the data samples associated with the set. On the other hand, a set has some unique features not present in a regular field. FIG. 4F depicts a first bar chart that has a single bar 419 representing the total amount of campaign contributions to both candidates from different states. FIG. 4G depicts a second bar chart after the user drags and drops the “More $ to Romney” set from the set region 404 into the row shelf 408. Note that the set name “More $ to Romney” in the row shelf 408 is shown as “IN/OUT(More $ to Romney).” Upon detecting the set name “More $ to Romney” in the row shelf 408, the computer aggregates the total amount of campaign contributions from the states listed in the “More $ to Romney” set and the total amount of campaign contributions from the states not listed in or out of the “More $ to Romney” set, respectively. As a result, the single bar 419 in FIG. 4F is split into two bars 421 and 423 in FIG. 4G, the bar 421 representing the total amount of campaign contributions in the “More $ to Romney” set and the bar 421 representing the total amount of campaign contributions out of the “More $ to Romney” set, i.e., the total amount of campaign contributions to President Obama, without having to generate a separate data structure or an equivalent express such as “More $ Obama.” From the bar chart shown in FIG. 4G, a user can easily tell that President Obama received more campaign contributions from the 50 states than Governor Romney and, more importantly, the difference in the total amount of campaign contributions is about $200 million. Note that the aggregation associated with the IN/OUT( ) operator may be one selected from the group consisting of sum, average, median, count, standard deviation, variance, maximum, and minimum. For example, the default choice of the aggregation is sum and a user can select from a drop-down menu associated with the IN/OUT( ) operator a different aggregation operation.

In other words, a set defined in the present application is associated with a special operator called “IN/OUT( )” When the set is dropped into one of the shelves shown in FIG. 4A, the computer processes the data samples associated with the marks that was not highlighted at the time of creating the set such that were the processing result of the data samples in the set can be compared side by side with the processing result of the data samples out of the set.

In some implementations, a user may need to expand the aggregated data view of a set into visualization of individual members in the set. FIG. 3B is a flow chart illustrating how to achieve this goal by issuing a third user instructions to a graphical user interface. In response to detecting (307) the third user instruction, the computer replaces (309) the first mark, which corresponds to an aggregated view, with a group of marks on the display, each mark in the group corresponding to a respective data sample in the first data structure. As shown in FIG. 4H, a user click on the “IN/OUT(More $ to Romney)” operator 425 causes a drop-down menu 427 to be rendered on the display, the menu including a “Show Members in Set” option 429. In response to a user selection of the option 429, the aggregated data view is then replaced with a new data view shown in FIG. 4I. The new view is also a bar chart, each bar representing the amount of campaign contributions from an individual state in the “More $ to Romney” set. Meanwhile or subsequently, the “IN/OUT(More $ to Romney)” operator 425 is replaced with the “More $ to Romney” operator 431, indicating that the data view is no longer a result of applying the IN/OUT( ) operator to the sum of the campaign contributions from the 50 states. Of course, the user can return to the aggregated view by clicking the drop-down menu button of the “More $ to Romney” operator 431. Moreover, the user can repeat the same set generation process described above to the bar chart shown in FIG. 4I. For example, the user can generate a new set for Florida and Texas in order to compare the total amount of campaign contributions from the top-two states with the total amount of campaign contributions from the other states.

Besides the IN/OUT( ) operation associated with a particular set such as the “More $ to Romney” set, a user may apply other types of operations to multiple sets, including union, intersection, complement, and Cartesian product. FIG. 3C is a flow chart illustrating how to apply the set-related operations to multiple sets through a graphical user interface. In response to detecting (311) a fifth user instruction, the computer visually highlights (313) a second subset of the plurality of marks in accordance with the fifth user instruction and generates a second data structure including the data samples associated with the second subset of highlighted marks. Then in response to detecting (315) a sixth user instruction, the computer generates (317) a third data structure by applying a predefined operation to the first data structure and the second data structure and a data view for visualizing the third data structure.

FIG. 4J is an exemplary screenshot of a data view illustrating the member states in the “More $ to Romney” set on the US map. The fact that Governor Romney received more campaign contributions from these states indicated that he was likely to prevail in these states in the 2012 presidential election. FIG. 4K is an exemplary screenshot of a data view of another set of states called “Voted Obama '08,” i.e., the states that President Obama carried in the 2008 presidential election. Given the nature of the US election system, people are more interested in finding out those “swing” states, i.e., the states that may switch from one camp to the other camp. For example, a state that voted for President Obama in 2008 but makes more campaign donation to Governor Romney in the 2012 election may be a potential swing state. States of this nature can be easily identified by applying an intersection operation to the two sets, the “More $ to Romney” set and the “Voted Obama '08” set.

To do so, a user first selects the two sets in the “Set” region 404 shown in FIG. 4A and then creates a combined set from the two sets. FIG. 4K is an exemplary screenshot of a pop-up window that includes four different ways of combining the two sets 433 and 435, they are:
All Members in Both Sets 437;
Shared Members in Both Sets 439;
“More $ to Romney” except shared members 441; and
“Voted Obama '08” except shared members 443.

In this example, the “swing” states are those with shared members in both sets 439. Therefore, the user can select the corresponding toggle icon and then click the “OK” button to generate a third set called “Swing States” for those states that voted for Obama in 2008 but made more contributions to Romney's campaign in 2012. FIG. 4M depicts a data view of the members in the “Swing States” set on the US map, including Nevada, Florida, Indiana, Michigan, and Ohio.

In some implementations, the members in a set are fixed. For example, the states that voted for President Obama in 2008 are known and the “Voted Obama '08” set is therefore referred to as a “static set.” In some other implementations, the members in a set are not fixed and such a set is referred to as a “dynamic set.” FIG. 4N is an exemplary screenshot of a dynamic set called “Top N States,” representing the top campaign contributions giving states. In this example, the top 10 states are shown in the form of a bar chart. But a user can change the parameter “N” from 10 to 5 or to 20 using the sliding bar 445. In order to compare the campaign contributions from the top N states with those from the other states as a whole, a user can define a formula and generate a customized field using the formula as shown in FIG. 4O. In this example, the customized field is named as “Top N or Other” and the formula is defined as follows:

```
IF [Top N States] THEN
    [State]
ELSE
    “Other”
END
```

In other words, if a state is a member of the “Top N States” set, its campaign contribution is kept as a separate value of the “Top N or Other” customized field without being merged with the campaign contributions from other states. If not, the state's campaign contribution is merged with the campaign contributions from other states not in the “Top N States” set. By doing so, the computer effectively generates a new set that has one more member than the “Top N States” set, i.e., “Other,” and the aggregation only occurs to the states associated with the “Other” value but not to the top N campaign donation states. FIG. 4P is an exemplary screenshot of a bar chart of the “Top N or Other” customized field. Note that the campaign contributions from California alone are about half of all the campaign contributions from the other 40 states. FIG. 4Q is an exemplary screenshot of the same bar chart of the “Top N or Other” customized field after being sorted. As mentioned above, the “Top N States” set is a dynamic set and a user can change its member states through the sliding bar 445. In this example, the “Top N States” set increases its members from 10 to 16. Because the “Top N or Other” is a calculated field, the sum of the campaign contributions from the other 34 states reduces when six additional states are taken out of the “Other” field. From this bar chart, it is not difficult to find out that the campaign contributions from California alone are approximately the same as the total amount of campaign contributions from the other 34 states.

While particular implementations are described above, it will be understood it is not intended to limit the invention to these particular implementations. On the contrary, the invention includes alternatives, modifications and equivalents that are within the spirit and scope of the appended claims. Numerous specific details are set forth in order to provide a thorough understanding of the subject matter presented herein. But it will be apparent to one of ordinary skill in the art that the subject matter may be practiced without these specific details. In other instances, well-known methods, procedures, components, and circuits have not been described in detail so as not to unnecessarily obscure aspects of the implementations.

Although the terms first, second, etc. may be used herein to describe various elements, these elements should not be limited by these terms. These terms are only used to distinguish one element from another. For example, first ranking criteria could be termed second ranking criteria, and, similarly, second ranking criteria could be termed first ranking criteria, without departing from the scope of the present invention. First ranking criteria and second ranking criteria are both ranking criteria, but they are not the same ranking criteria.

The terminology used in the description of the invention herein is for the purpose of describing particular implementations only and is not intended to be limiting of the invention. As used in the description of the invention and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, operations, elements, and/or components, but do not preclude the presence or addition of one or more other features, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

Although some of the various drawings illustrate a number of logical stages in a particular order, stages that are not order dependent may be reordered and other stages may be combined or broken out. While some reordering or other groupings are specifically mentioned, others will be obvious to those of ordinary skill in the art and so do not present an exhaustive list of alternatives. Moreover, it should be recognized that the stages could be implemented in hardware, firmware, software or any combination thereof.

The foregoing description, for purpose of explanation, has been described with reference to specific implementations. However, the illustrative discussions above are not intended to be exhaustive or to limit the invention to the precise forms disclosed. Many modifications and variations are possible in view of the above teachings. The implementations were chosen and described in order to best explain principles of the invention and its practical applications, to thereby enable others skilled in the art to best utilize the invention and various implementations with various modifications as are suited to the particular use contemplated. Implementations include alternatives, modifications and equivalents that are within the spirit and scope of the appended claims. Numerous specific details are set forth in order to provide a thorough understanding of the subject matter presented herein. But it will be apparent to one of ordinary skill in the art that the subject matter may be practiced without these specific details. In other instances, well-known methods, procedures, components, and circuits have not been described in detail so as not to unnecessarily obscure aspects of the implementations.

What is claimed is:

1. A computer-implemented method of visualizing a dataset, comprising:
at a computer having memory, one or more processors, and a display:
rendering a plurality of marks on the display, each mark corresponding to a respective data sample in the dataset;
in response to detecting a first user instruction, visually highlighting a subset of the plurality of marks in accordance with the first user instruction and generating a first data structure including the data samples associated with the highlighted marks; and
in response to detecting a second user instruction, replacing the plurality of marks with two marks on the display, wherein a first mark corresponds to an aggregation result of the data samples associated with the highlighted marks and a second mark corresponds to an aggregation result of data samples associated with the non-highlighted marks.

2. The method of claim 1, further comprising:
in response to detecting a third user instruction, replacing the first mark with a group of marks on the display, wherein each mark in the group corresponds to a respective data sample in the first data structure.

3. The method of claim 1, wherein the aggregation is one selected from the group consisting of sum, average, median, count, standard deviation, variance, maximum, and minimum.

4. The method of claim 1, further comprising:
in response to detecting the first user instruction, displaying a table of entries in a pop-up window, each table entry corresponding to a respective data sample associated with one of the highlighted marks;
in response to detecting a fourth user instruction:
removing a table entry from the pop-up window and a data sample corresponding to the removed table entry from the first data structure; and
de-highlighting a mark associated with the data sample.

5. The method of claim 1, further comprising:
in response to detecting a fifth user instruction, visually highlighting a second subset of the plurality of marks in accordance with the fifth user instruction and generating a second data structure including the data samples associated with the second subset of highlighted marks; and
in response to detecting a sixth user instruction, generating a third data structure by applying a predefined operation to the first data structure and the second data structure and a data view for visualizing the third data structure.

6. The method of claim 5, wherein the predefined operation is one selected from the group consisting of union, intersection, complement, and Cartesian product.

7. The method of claim 1, wherein a data sample includes multiple data values, each data value corresponding to a respective field of the dataset.

8. The method of claim 1, wherein a data sample includes a single data value corresponding to a field of the dataset.

9. A computer system for visualizing a dataset, comprising:
one or more processors;
a display; and
memory storing one or more programs, wherein the one or more programs are configured to, when executed by the one or more processors, cause the one or more processors to:
render a plurality of marks on the display, each mark corresponding to a respective data sample in the dataset;
in response to detecting a first user instruction, visually highlight a subset of the plurality of marks in accordance with the first user instruction and generate a first data structure including the data samples associated with the highlighted marks; and
in response to detecting a second user instruction, replace the plurality of marks with two marks on the display, wherein a first mark corresponds to an aggregation result of the data samples associated with the highlighted marks and a second mark corresponds to an aggregation result of data samples associated with the non-highlighted marks.

10. The computer system of claim 9, further comprising:
in response to detecting a third user instruction, replacing the first mark with a group of marks on the display, wherein each mark in the group corresponds to a respective data sample in the first data structure.

11. The computer system of claim 9, wherein the aggregation is one selected from the group consisting of sum, average, median, count, standard deviation, variance, maximum, and minimum.

12. The computer system of claim 9, further comprising:
in response to detecting the first user instruction, displaying a table of entries in a pop-up window, each table entry corresponding to a respective data sample associated with one of the highlighted marks;
in response to detecting a fourth user instruction:
removing a table entry from the pop-up window and a data sample corresponding to the removed table entry from the first data structure; and
de-highlighting a mark associated with the data sample.

13. The computer system of claim 9, further comprising:
in response to detecting a fifth user instruction, visually highlighting a second subset of the plurality of marks in accordance with the fifth user instruction and generating a second data structure including the data samples associated with the second subset of highlighted marks; and
in response to detecting a sixth user instruction, generating a third data structure by applying a predefined operation to the first data structure and the second data structure and a data view for visualizing the third data structure.

14. The computer system of claim 13, wherein the predefined operation is one selected from the group consisting of union, intersection, complement, and Cartesian product.

15. The computer system of claim 9, wherein a data sample includes multiple data values, each data value corresponding to a respective field of the dataset.

16. The computer system of claim 9, wherein a data sample includes a single data value corresponding to a field of the dataset.

17. A non-transitory computer readable storage medium storing one or more programs configured for execution by a computer system that includes one or more processors, a display, and memory storing one or more programs, the one or more programs comprising instructions for:
rendering a plurality of marks on the display, each mark corresponding to a respective data sample in the dataset;
in response to detecting a first user instruction, visually highlighting a subset of the plurality of marks in accordance with the first user instruction and generating a first data structure including the data samples associated with the highlighted marks; and
in response to detecting a second user instruction, replacing the plurality of marks with two marks on the display, wherein a first mark corresponds to an aggregation result of the data samples associated with the highlighted marks and a second mark corresponds to an aggregation result of data samples associated with the non-highlighted marks.

18. The non-transitory computer readable storage medium of claim 17, further comprising:
in response to detecting a third user instruction, replacing the first mark with a group of marks on the display, wherein each mark in the group corresponds to a respective data sample in the first data structure.

19. The non-transitory computer readable storage medium of claim 17, wherein the aggregation is one selected from the group consisting of sum, average, median, count, standard deviation, variance, maximum, and minimum.

20. The non-transitory computer readable storage medium of claim 17, further comprising:
in response to detecting the first user instruction, displaying a table of entries in a pop-up window, each table entry corresponding to a respective data sample associated with one of the highlighted marks;
in response to detecting a fourth user instruction:
removing a table entry from the pop-up window and a data sample corresponding to the removed table entry from the first data structure; and
de-highlighting a mark associated with the data sample.

21. The non-transitory computer readable storage medium of claim 17, further comprising:
in response to detecting a fifth user instruction, visually highlighting a second subset of the plurality of marks in accordance with the fifth user instruction and generating a second data structure including the data samples associated with the second subset of highlighted marks; and
in response to detecting a sixth user instruction, generating a third data structure by applying a predefined operation to the first data structure and the second data structure and a data view for visualizing the third data structure.

22. The non-transitory computer readable storage medium of claim 21, wherein the predefined operation is one selected from the group consisting of union, intersection, complement, and Cartesian product.

23. The non-transitory computer readable storage medium of claim 17, wherein a data sample includes multiple data values, each data value corresponding to a respective field of the dataset.

24. The non-transitory computer readable storage medium of claim 17, wherein a data sample includes a single data value corresponding to a field of the dataset.
